(19) United States
(12) Patent Application Publication
(10) Pub. No.: US 2016/0071049 A1
(43) Pub. Date: Mar. 10, 2016

(54) BROKERING SERVICES

(71) Applicant: Amazon Technologies, Inc., Seattle, WA (US)

(72) Inventor: Zahur Peracha, Irvine, CA (US)

(21) Appl. No.: 14/940,534

(22) Filed: Nov. 13, 2015

Related U.S. Application Data
(63) Continuation of application No. 13/296,797, filed on Nov. 15, 2011.

(51) Int. Cl. G06Q 10/06

(52) U.S. Cl. CPC G06Q 10/063114

(57) ABSTRACT

Disclosed are various embodiments for defining tasks to be assigned to a service provider. In one embodiment, a specification of a service provider availability of a service provider from a client device is facilitated over a publically accessible network. At least one of a plurality of tasks are identified that are compatible with the service provider availability. One of a plurality of fulfillment alternatives is automatically selected for each identified at least one of the tasks. The identified at least one of the tasks is assigned to the service provider for fulfillment.

### CROSS-REFERENCE TO RELATED APPLICATIONS

This application claims the benefit of U.S. Non-Provisional application Ser. No. 13/296,797, filed Nov. 15, 2011, the entire contents of which is hereby incorporated herein by reference.

### BACKGROUND

Often individuals need help performing various tasks that arise during the ordinary course of living. For example, such tasks may involve running errands, walking dogs, and other tasks. Unfortunately, it can be difficult to find reliable individuals to perform such tasks.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of a networked environment according to various embodiments of the present disclosure.

FIG. 2 is a drawing of an example of a user interface rendered by a service requestor client in the networked environment of FIG. 1 according to various embodiments of the present disclosure.

FIG. 3 is a drawing of an example of a user interface rendered by a service provider client in the networked environment of FIG. 1 according to various embodiments of the present disclosure.

FIG. 4 is a drawing of another example of a user interface rendered by a service provider client in the networked environment of FIG. 1 according to various embodiments of the present disclosure.

FIG. 5 is a flowchart illustrating one example of functionality implemented as portions of a service broker system executed in a computing device in the networked environment of FIG. 1 according to various embodiments of the present disclosure.

FIG. 6 is a flowchart illustrating another example of functionality implemented as portions of a service broker system executed in a computing device in the networked environment of FIG. 1 according to various embodiments of the present disclosure.

FIG. 7 is a schematic block diagram that provides one example illustration of a computing device employed in the networked environment of FIG. 1 according to various embodiments of the present disclosure.

### DETAILED DESCRIPTION

Various approaches to facilitate the performance of tasks by service providers is discussed. Service requestors enter descriptions of tasks in a service broker system. Also, service providers enter their availability to perform the tasks requested by the service requestors. The service broker system takes action to properly define the details of tasks where needed and generates task lists of tasks to perform for the service providers. The task lists are optimized based on one or more factors. In the following discussion, a general description of the system and its components is provided, followed by a discussion of the operation of the same.

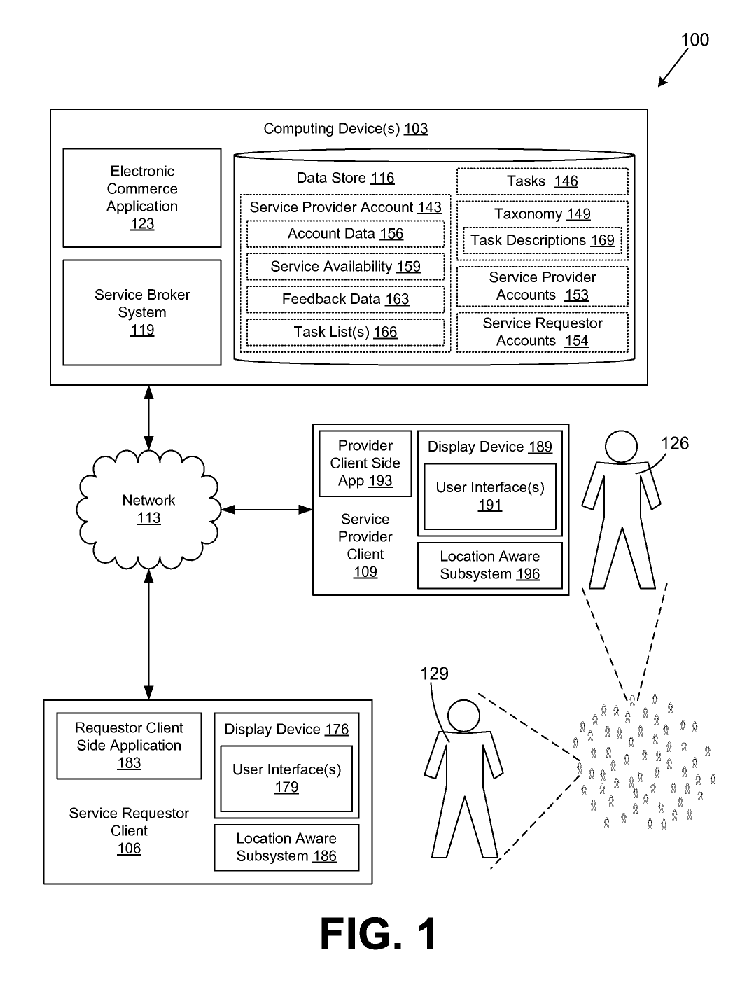

With reference to FIG. 1, shown is a networked environment 100 that includes a computing device 103, service requestor clients 106, and service provider clients 109, each of which is coupled to a network 113. The network 113 includes, for example, the Internet, intranets, extranets, wide area networks (WANs), local area networks (LANs), wired networks, wireless networks, or other suitable networks, etc., or any combination of two or more such networks.

The computing device 103 may comprise, for example, a server computer or any other system providing computing capability. Alternatively, a plurality of computing devices 103 may be employed that are arranged, for example, in one or more server banks or computer banks or other arrangements. For example, a plurality of computing devices 103 together may comprise a cloud computing resource, a grid computing resource, and/or any other distributed computing arrangement. Such computing devices 103 may be located in a single installation or may be distributed among many different geographical locations. For purposes of convenience, the computing device 103 is referred to herein in the singular. Even though the computing device is referred to in the singular, it is understood that a plurality of computing devices 103 may be employed in the various arrangements as described above.

Various applications and/or other functionality may be executed in the computing device 103 according to various embodiments. Also, various data is stored in a data store 116 that is accessible to the computing device 103. The data store 116 may be representative of a plurality of data stores as can be appreciated. The data stored in the data store 116, for example, is associated with the operation of the various applications and/or functional entities described below.

The components executed on the computing device 103, for example, include a service broker system 119, an electronic commerce system 123, and other applications, services, processes, systems, engines, or functionality not discussed in detail herein.

The service broker system 119 is executed in order to facilitate performance of tasks by a plurality of service providers 126, where the tasks are submitted by service requestors 129 as will be described.

The electronic commerce system 123 is executed in order to facilitate the online purchase of items over the network 113. The electronic commerce system 123 also performs various backend functions associated with the online presence of a merchant in order to facilitate the online purchase of items as will be described. For example, in one embodiment the electronic commerce system 123 generates network pages such as web pages or other types of network content that are provided to clients computing devices for the purposes of selecting items for purchase, rental, download, lease, or other form of consumption as will be described.

The data stored in the data store 116 includes, for example, service provider accounts 143, a number of tasks 146, a taxonomy 149, service requestor accounts 153, service provider accounts 154, and potentially other data. The service provider accounts 143 each comprise information associated with a given service provider 126. Such service providers 126 are individuals who perform various tasks 146 as will be described. The service provider accounts 143 include account data 156, instances of service provider availability 159, feedback data 163, task lists 166, and potentially other information.

The account data 156 includes general information about the service provider 126 including, for example, their name, address, billing address, payment instrument information, and other information needed to facilitate assigning tasks 146 to the service provider 126 as will be described. The service provider availability 159 comprises information that indicates an availability in terms of time periods and other variables that are considered to determine if a service provider 126 can perform various tasks 146 as will be described. Multiple instances of service provider availability 159 may be specified as will be described.

The feedback data 163 includes reviews, ratings, or other critiques of the performance of a service provider 126 as will be described. The task lists 166 include listings of tasks 146 to be performed by a given service provider 126 at predefined time intervals specified by a respective instance of service provider availability 159 as will be described. Each task 146 is specified by a service requestor 129 to be performed by a service provider 126. The tasks 146 may vary in scope as will be described.

The taxonomy 149 includes a hierarchy of task descriptions 169 of the various tasks 146 that may be specified by the service requestor 129 and performed by a respective service provider 126. To this end, the taxonomy 149 facilitates the specification of the tasks 146 by service requestors 129 and the selection of such tasks 146 to be performed by service providers 126 as will be described.

A service provider account 153 includes specific information about a respective service provider 126 to facilitate their interaction with the service broker system 119. To this end, the service provider account 153 may include information such as, for example, a name of a service provider 126, a location such as an address of such service provider 126, the username and password to log into the service broker system 119, and other information.

A service requestor account 154 includes specific information about a respective service requestor 129 to facilitate their interaction with the service broker system 119. To this end, the service requestor account 154 may include information such as, for example, a name of a service requestor 129, a location such as an address of the service requestor 129, the username and password to log into the service broker system 119, payment instrument information, and other information. In addition, there may be other data that is stored in the data store and accessible by the service broker system 119 in the electronic commerce application 123 as can be appreciated.

The service requestor client 106 is representative of a plurality of client devices that may be coupled to the network 113. The service requestor client 106 may comprise, for example, a processor-based system such as a computer system. Such a computer system may be embodied in the form of a desktop computer, a laptop computer, a personal digital assistant, a cellular telephone, set-top box, music players, web pads, tablet computer systems, game consoles, or other devices with like capability. The service requestor client 106 includes a display device 176 upon which various user interfaces 179 may be rendered. The display device 176 may comprise, for example, a liquid crystal display (LCD), a plasma based display, a cathode ray tube, or other type of display device as can be appreciated.

The service requestor client 106 may be configured to execute various applications such as a requestor client-side application 183 that facilitates interaction with the service broker system 119. In one embodiment, the service broker system 119 may comprise a web application that serves up network content such as web pages, and the requestor client-side application 183 comprises a browser. Alternatively, the requestor client-side application 183 comprises a dedicated application configured to interact with the service broker system 119 as will be described.

The user interface 179 may comprise, for example, a network page such as a web page serviced up by the service broker system 119 where the requestor client-side application 183 comprises a browser. As another alternative, the user interface 179 may comprise a dedicated interface generated by the requestor client-side application 183.

In addition, the service requestor client 106 includes a location aware subsystem 186. The location aware subsystem 186 may comprise a global positioning system (GPS) or other system that facilitates generating a location of the service requestor client 106 at any given time. Also, the service requestor client 106 may be configured to execute applications beyond the requestor client-side application 183 and the location aware subsystem 186 such as, for example, email applications, instant message applications, and/or other applications.

The service provider client 109 is representative of a plurality of further client devices that may be coupled to the network 113. The service provider client 109 may comprise, for example, a processor-based system such as a computer system. Such a computer system may be embodied in the form of a desktop computer, a laptop computer, a personal digital assistant, a cellular telephone, set-top box, music players, web pads, tablet computer systems, game consoles, or other devices with like capability. The service provider client 109 includes a display device 189 upon which various user interfaces 191 may be rendered. The display device 189 may comprise, for example, a liquid crystal display (LCD), a plasma based display, a cathode ray tube, or other type of display device as can be appreciated.

The service provider client 109 may be configured to execute various applications such as a provider client-side application 193 that facilitates interaction with the service broker system 119. In one embodiment, the service broker system 119 may comprise a web application that serves up network content such as web pages, and the provider client-side application 193 comprises a browser. Alternatively, the provider client-side application 193 comprises a dedicated application configured to interact with the service broker system 119 as will be described.

The user interface 191 may comprise, for example, a network page such as a web page serviced up by the service broker system 119 where the provider client-side application 193 comprises a browser. As another alternative, the user interface 191 may comprise a dedicated interface generated by the provider client-side application 193.

In addition, the service provider client 109 includes a location aware subsystem 196. The location aware subsystem 196 may comprise a global positioning system (GPS) or other system that facilitates generating a location of the service provider client 109 at any given time. Also, the service provider client 109 may be configured to execute applications beyond the provider client-side application 193 and the location aware subsystem 196 such as, for example, email applications, instant message applications, and/or other applications.

Next, a general description of the operation of the various components of the networked environment 100 is provided. The service broker system 119 advantageously facilitates matching service providers 126 to service requestors 129 so that various tasks 146 may be performed by the service providers 126 for the service requestors 129. In one embodiment, each service provider 126 may manipulate the service provider client 109 to interact with the service broker system 119. To this end, the service provider 126 may manipulate the provider client-side application 193 to access network content from the service broker system 119 in order to facilitate a specification of instances of the service provider availability 159 to perform various tasks 146. In specifying an instance of service provider availability 159, a service provider 126 may specify a window of time in which they are available, the type of tasks 146 the service provider is willing to perform, a location where they can perform tasks 146, and other information as will be described. In specifying an instance of service provider availability 159, the service provider 126 may take advantage of the taxonomy 149 that lists the task descriptions 169 as will be described.

The service requestors 129 may manipulate the requestor client-side application 183 to interact with the service broker system 119 to specify tasks 146 that are to be performed by service providers 126. In this respect, the requestor client-side application 186 was configured to generate various user interfaces 179 from network content obtained from the service broker system 119 to facilitate a specification of the tasks 146. In specifying respective tasks 146, the service requestor 129 may take advantage of the task descriptions 169 in the taxonomy 149.

The tasks 146 may vary depending on the needs of the service requestors 129. Typical tasks 146 may comprise, for example, performing various errands such as delivering items such as prescriptions, groceries, dry cleaning, or other items. The tasks 146 may also comprise performing shopping duties such as shopping for groceries or other items. The tasks 146 may further involve the care of pets including walking a dog, feeding animals, grooming animals, cleaning animal habitats, or other types of tasks 146. Such tasks may be related to an average household in a given day based on the needs of a service requestor 129. Alternatively, such tasks 146 may be related to the operation of commercial enterprises as can be appreciated.

Ultimately, a service requestor 129 identifies various tasks 146 they wish to have performed. In such a case, some of the tasks 146 may have various fulfillment options that have not been specified in detail by the service requestor 129. For example, in specifying a task 146 of shopping for certain grocery items, it may be the case that the service requestor 129 did not specify the specific grocery store or other fulfillment venue that is to be used to perform the shopping task 146. Other tasks 146 are well defined and leave little room for improvisation or other types of changes as will be described.

Once a sufficient number of tasks 146 and instances of provider availability 159 are stored in the data store 116, the service broker system 119 is then able to generate task lists 166 for the service providers 126. Before generating a task list 166, the service broker system 119 is configured to ensure the tasks 146 are fully defined. Such tasks 146 may have been set forth in various service requests from service requestors 129 that have fulfillment options that have not been specified.

According to one embodiment, the service broker system 119 is configured to define each of the tasks 146 that are not fully defined. In doing so, various factors may be considered for the fulfillment of the respective task 146 in deciding which fulfillment option is to be employed. Various fulfillment options may comprise, for example, fulfillment venues to be employed (e.g. which stores to frequent), modes of transportation to be employed by the service provider 126 in performing a task 146, and other fulfillment options as will be described.

When the tasks 146 are fully defined, the service broker system 119 then generates the task lists 166 comprising one or more tasks 146 for a given service provider 126 to perform. In this respect, the service broker system 119 may first identify a subset of tasks 146 that are ultimately compatible with a given instance of service provider availability 159 for a given service provider 126. Thereafter, a task list 166 may be determined for the respective service provider 126 for the respective instance of the service provider availability 159, where the task list 169 sets forth the tasks 146 that are to be fulfilled by the service provider 126.

In generating a task list 166 of compatible tasks 146, according to one embodiment, the service broker system 119 attempts to generate an optimal task list 166 based on a number of factors or considerations. For example, various factors to consider may include, for example, an implementation efficiency of the tasks 146, a cost to the service provider 126, a cost to the service requestor 129, or other factors as will be described in detail below.

In addition, the service broker system 119 may facilitate the maintenance of a feedback system that allows service requestors 129 to post feedback in the form of reviews of the performance of a given service provider 126 in completing a task 146. Such reviews may comprise, for example, a paragraph describing performance, a star rating, or other type of rating or indication of performance.

Similarly, the service provider 126 may interact with the service broker system 119 to leave feedback or reviews relating to the behavior of the service requestor 129. Such feedback may be left in the same format as the feedback from the service requestor 129 described above. To this end, the service provider 126 may indicate whether the service requestor 129 paid in a timely manner, imposed undue burdens on the service provider 126 in performing the tasks 146, or other behavior as can be appreciated.

In the discussion that follows, various user interfaces 179 and 191 are described to show the interaction of the service providers 126 and the service requestors 129 with the service broker system 119. Various graphical user components are depicted in such user interfaces 179/191 such as, for example, push buttons, text fields, pick lists, check boxes, and other components. It is understood that the various components shown are merely examples of the many different kinds of graphical components that may be used to accomplish the same underlying purposes as can be appreciated.

In addition, the service broker system 119 is configured to act as an intermediary to facilitate transfer of payment from the service requestor 129 to the service provider 126 for tasks 146 performed. To this end, an account may be maintained for the service provider 126 for the deposit and temporary storage of funds until accessed by the service provider 126. Such payments may be obtained by charging a credit card of the service requestor 129 or via some other method of payment.

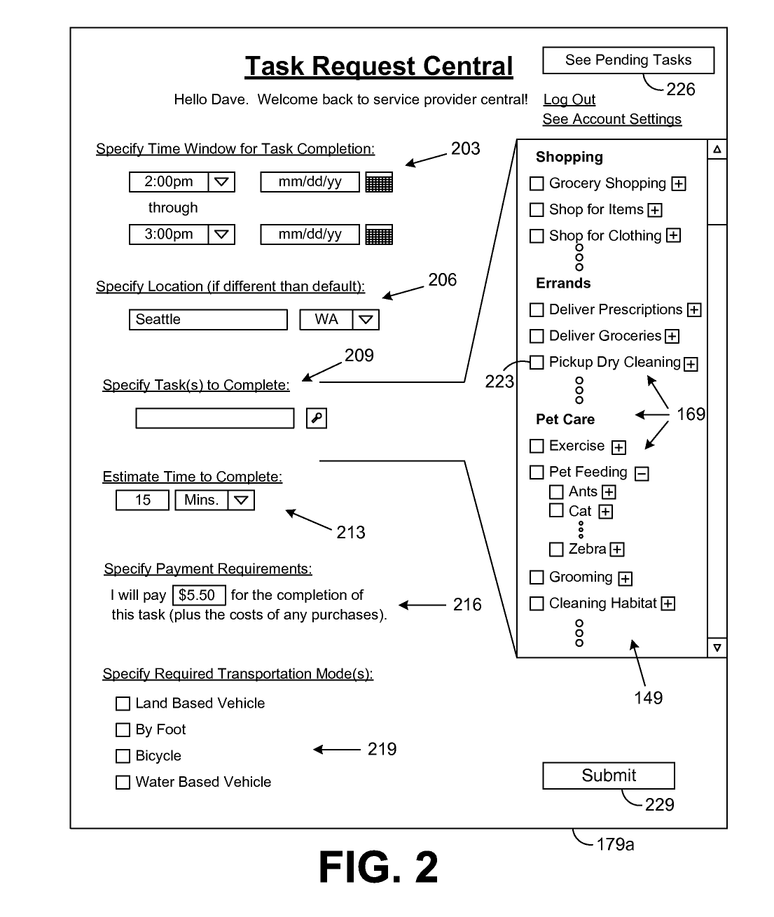

With reference to FIG. 2, shown is a user interface 179, denoted herein as user interface 179a, according to various embodiments of the present disclosure. The user interface 179a is presented to the service requestor 129 (FIG. 1) on the service requestor client 106 (FIG. 1) in order to generate a service request that sets forth a given task 146 (FIG. 1) by a requestor 129. In one embodiment, the user interface 179a is encoded for display to facilitate a specification of a respective task 146 in conjunction with a service request.

It is assumed that the service broker system 119 (FIG. 1) will have taken steps to authenticate a given service requestor 129 for presenting the user interface 179a. This may be done, for example, by requiring a username and password to be entered in an appropriate interface or by obtaining other information from the service requestor 129 as can be appreciated.

The user interface 179a includes various components such as time window specification components 203, location specification components 206, and task search components 209. The user interface 179a further includes completion time estimation components 213, payment specification components 216, and transportation mode specification components 219. In addition, the user interface 179a presents at least a portion of the taxonomy 149 that includes task descriptions 169 as described above. Associated with each task description 169 is a check box 223 as shown. Further, the user interface 179a includes a “see pending tasks” button 226, a “submit” button 229, and potentially other buttons.

The time window specification component 203 facilitates specification of a time window within which the service requestor 129 wishes a given task 146 to be performed. To this end, the time window specification component 123 provides the input of the begin and end times as well as the dates of such times as shown. Alternatively, only an end time may be specified if it does not matter when a given task 146 is started. The location specification component 206 facilitates the specification by the service requestor 129 of the location where the task 146 is to be performed. In one embodiment, the location may be specified in terms of a city/state, country/state, or other designation. Alternatively, the location may be specified in terms of an address, etc.

The task search component 209 facilitates searching through the various predefined tasks 146 that the service broker system 119 brokers. Such predefined tasks 146 may be stored in terms of the task descriptions 169 in the taxonomy 149. According to one embodiment, the task search component 209 comprises a text box that facilitates the entry of search terms that may be employed to search through the various task descriptions 169 to identify potential tasks 146 that a service requestor 129 wishes to have completed. Alternatively, the service requestor 129 may browse through the taxonomy 149 and click on the check boxes 223 associated with each one of the task descriptions 169 of interest. It is understood that respective task descriptions 169 may have subordinate descriptions that provide greater detail. For example, where a task description 169 comprises “pet feeding,” it may be the case that subordinate concepts involve the different types of animals that have to be fed as shown in FIG. 2. In one embodiment, it may be possible that multiple tasks may be specified by a given requestor 129 in a single instance of interaction with the user interface 179a.

The completion time estimation component 213 allows the service requestor 129 to specify an estimate of the time necessary to complete a specified task 146. This allows the service broker system 119 to determine those tasks 146 that are compatible with the service provider availability 159 of a respective service provider 126 as will be described. In addition, standard completion times may be maintained by the service broker system 119 that are generated as an average or other derivation of the completion times entered by many service requestors 129 over time. To the extent that a given estimate appears to vary significantly from an average, a warning may be provided, etc.

The payment specification components 216 allow the service requestor to specify what they are willing to pay for the completion of one or more tasks 146. The payment specification component 216 may comprise a text box or other input device that facilitates the input of a given payment amount. Alternatively, payment may be specified in some other manner.

The transportation mode specification component 219 includes a listing of various modes of transportation that may be selected by the requestor 129. To this end, the requestor may particularly specify which mode of transportation that they wish the service provider to use in performing a given task 146. This may be important, for example, when tasks 146 are to be performed in locations where various modes of transportation are forbidden.

The various components set forth above may or may not be mandatory to be completed by a given service requestor 129. For example, it may not be necessary to specify a specific mode of transportation using the transportation mode specification component 219.

In addition, other items may be presented in the user interface 179a that are not disclosed herein. For example, for given tasks 146 specified, the service requestor 129 may specify a fulfillment venue to be employed by the service provider 126. For example, if a given task description 169 of grocery shopping is identified, then a further user interface 179 may be presented to a given service requestor 129 that facilitates a selection of a grocery store or other brick-and-mortar store that they prefer the service provider 126 to visit when performing the task 146.

In some embodiments, various fulfillment options specified by manipulating the respective components of the user interface 179a in specifying a task 146 may remain undefined. For example, as mentioned above, the service requestor 129 may not specify a mode of transportation to be employed via the transportation mode specification component 219. In such case, the service broker system 119 may be configured to ultimately select such fulfillment options to define a given task 146 completely so that it may be appropriately assigned to a given service provider 126. In an additional alternative, some of the various fulfillment options may be left open for the service provider 126 to choose their own desired approach to performing a given task 146.

In other cases, the service requestor 129 may fully define a given task 146. In this respect, by generating the user interface 179a, the service broker system 119 facilitates restricting the fulfillment of one or more tasks 146. For example, a task 146 may be restricted to a specific fulfillment venue. Also, a service provider 126 may be restricted to using a particular mode of transportation, or some other restriction may be specified.

The “see pending tasks” button 226 may be manipulated by a given service requestor 129 in order to generate subsequent user interfaces that show other tasks 146 that were previously specified by the service requestor 129. Also, the “submit” button 229 may be manipulated by the service requestor 129 to submit the task 146 to the service broker system 119 to be stored in the data store 116 to be assigned to a service provider 126 as will be described.

To the extent that the service broker system 119 generates the user interface 179a, then the service broker system 119 facilitates the input or specification of the various information required to define a task 146 as described above.

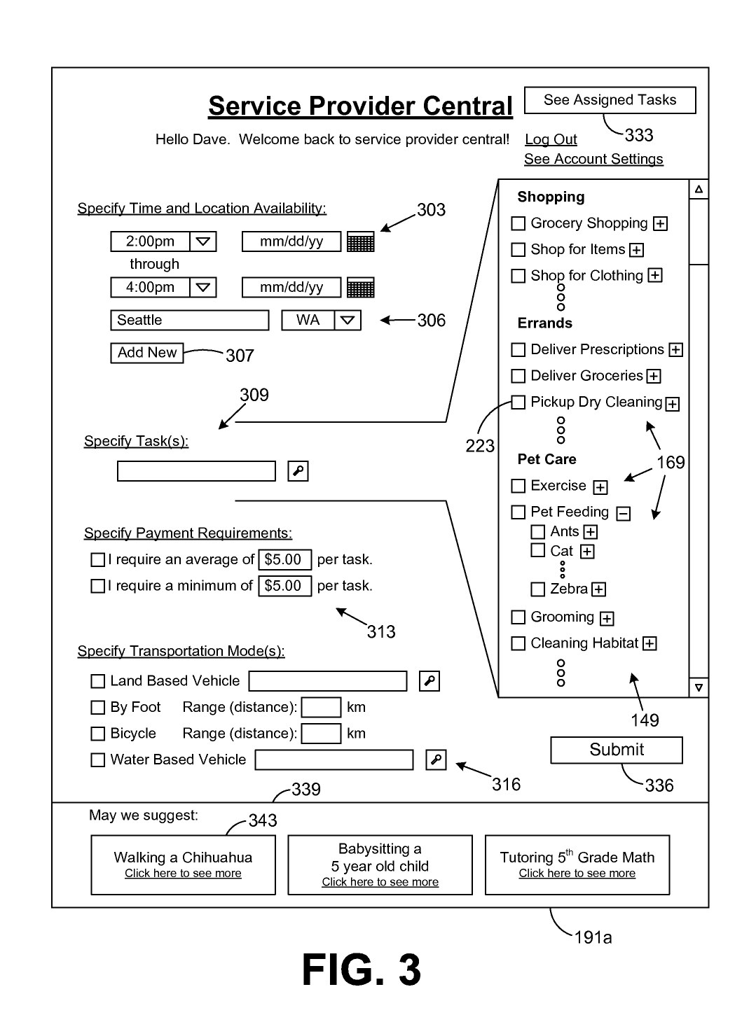

With reference to FIG. 3, shown is one example of a user interface 191, denoted herein as user interface 191a, according to various embodiments of the present disclosure. The user interface 191a is generated by the service broker system 119 (FIG. 1) and sent to the service provider client 109 (FIG. 1) to facilitate an input of an instance of service provider availability 159 (FIG. 1) to perform various tasks 146 (FIG. 1). In one embodiment, the user interface 191a is encoded for display to facilitate a specification of an instance of service provider availability 159 to perform various tasks 146.

The user interface 191a includes various components such as, for example, time window availability components 303, location availability components 306, an “add” button 307, and task search components 309. The user interface 191a further includes payment bid components 313 and possible transportation mode components 316. Further, the user interface 191a includes at least a partial listing of the task descriptions 169 of the taxonomy 149, where a check box 223 is noted next to each of the task descriptions 169. The user interface 191a also includes a “see assigned tasks” button 333, a “submit” button 336, and potentially other buttons.

Further, the user interface 191a includes a recommended tasks section 339 in which recommended tasks 343 for the service provider 126 are listed. Each of the recommended tasks 343 includes a link to subsequent network pages or other network content that describes the recommended task 343 that a given service provider 126 may be willing to perform. To this end, the recommended tasks section 339 is presented to suggest various tasks 146 to a service provider 126 that the service provider 126 may wish to perform.

The time window availability components 303 facilitate the specification of one or more time windows in which the service provider 126 is available to perform one or more tasks 146. The time window availability components 303 facilitate the specification of a start and end time for each specified time window, as well as calendar day for which such times are specified. In this manner, a service provider 126 can specify when they are available to perform tasks 146 as can be appreciated. The service provider 126 can specify multiple time windows of availability depending upon their own schedule on any given day, week, or other time period.

A location availability component 306 allows the service provider 126 to specify one or more locations where they will be during the respective one or more time windows specified in the time window availability components 303 to perform one or more tasks 146. While it may be the case that the service provider 126 is located near where they live most of the time, it is also possible that the service provider 126 may find themselves in other locations at various times. Consequently, the location availability component 306 allows the service provider 126 to specify a location where they anticipate they will be able to perform tasks 146 as desired. In one embodiment, a default location obtained from the service requestor account 153 may be prepopulated in the location availability component 306. The “add” button 307 is provided to allow a service provider 126 to specify multiple time windows and corresponding locations as shown.

The task search component 309 comprises a text box in which a search string may be entered to search through various possible tasks 146 that the service provider 126 may be willing to perform. Alternatively, a portion of a taxonomy 149 is presented that may be manipulated by the service provider 126 to indicate one or more tasks 146 for which they will be available to perform. To this end, the service provider 126 may indicate their willingness to perform a given task 146 or category of tasks by selecting a given check box 323 in front of a given task description 169, whether the task description 169 may be a specific task 146 or a category of tasks 146.

In the case that a search is performed using the task search component 309, subsequent user interfaces 191 may be presented to the service provider 126 to ultimately select various task descriptions 169 of tasks 146 that they are willing to perform as part of the specification of an instance of service provider availability 159.

The payment bid components 313 facilitate how much the service provider wishes to be paid. In this respect, a service provider 126 may submit a bid to perform various tasks 146. Given that multiple tasks 146 may be assigned to the service provider 126, the service provider 126 may specify either that they are only willing to perform a task 146 for a basic minimum payment. Alternatively, given that multiple tasks 146 may be stringed together in a given task list 166, the service provider 126 may specify an average minimum payment that must be received for all of the tasks 146.

In addition, there may be other ways of specifying payment that is to be received for given tasks 146. To the extent that a service provider 126 specifies desired payment for tasks 146 that is too high or otherwise unreasonable with respect to service requestors 129, then it may be the case that the service provider 126 is never assigned any tasks 146 to perform. In this respect, market forces may ultimately drive the prices paid for tasks 146 as can be appreciated.

The possible transportation mode components 316 facilitate those transportation modes that apply to a given service provider 126. The possible transportation mode components 316 may include check boxes for various transportation mode selections as well as additional components to specify a type of vehicle, a vehicle mileage, a maximum walking range, bicycle riding range, as well as a type of a water-based vehicle such as a boat. In addition, other types of information may be specified about possible transportation modes of a given service provider 126. In the context of providing vehicle information, such information allows the service broker system 119 to estimate a cost for a given service provider 126 to perform various tasks 146. For example, if one knows such factors as, for example, the average mileage a service provider 126 gets with their particular vehicle or other factors, a cost estimate for any travel such service provider 126 may incur can be estimated given an average cost of fuel.

The recommended tasks section 339 is presented to the service provider 126 through user interface 191a in order to recommend various tasks 146 to be performed by the service provider 126. The recommended tasks 343 may be generated by the service broker system 119 by examining the types of tasks 146 performed by a given service provider 126 in the past. Also, the feedback data 163 received by the service provider 126 in performing such tasks may be consulted. To this end, the service broker system 119 may suggest various tasks 146 that are the same type as those completed tasks 126 for which the service provider 126 received positive feedback in the form of the feedback data 163 as described above. Alternatively, the service broker system 119 may identify recommended tasks 343 that are similar to the tasks 146 previously performed by the service provider 126 in some way. For example, if the service provider 126 fed various types of animals in the past, then the feeding of different types of animals might be recommended in the recommended tasks 343.

The “see assigned tasks” button 333 may be manipulated so that the service provider 126 may view a subsequent user interface 191 that shows those tasks that have been assigned to the service provider 126 for a given time window of an instance of service provider availability 159 previously specified as will be described. Also, the “submit” button 336 may be manipulated to submit the settings that define an instance of service provider availability 159 to the service broker system 119 to be stored in the data store 116 (FIG. 1) as described above.

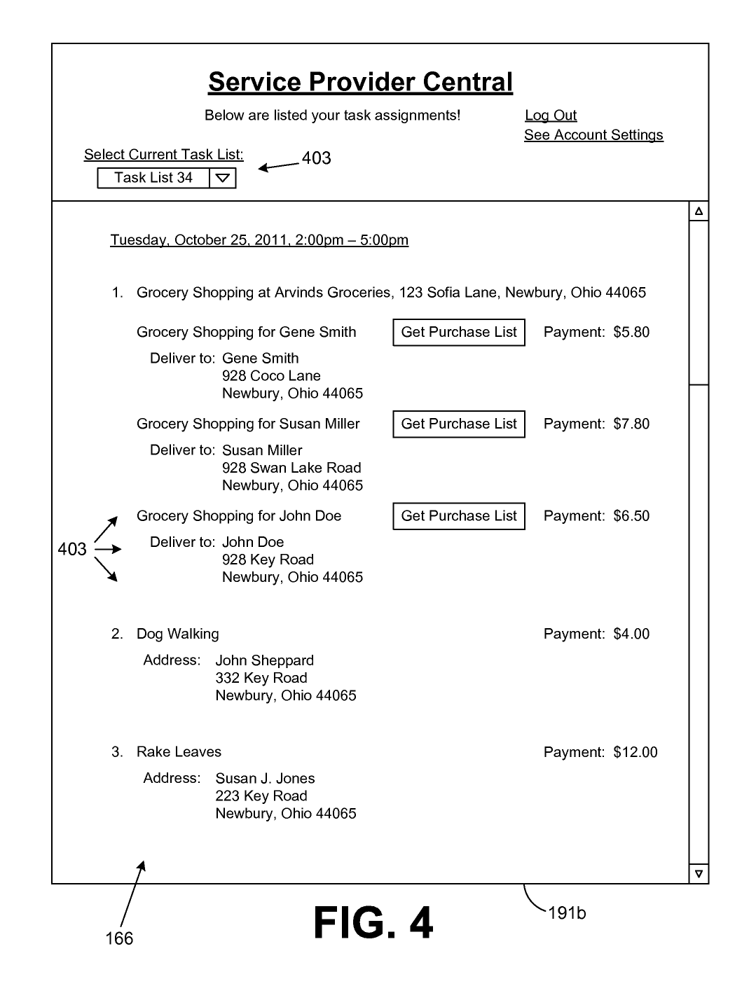

With reference next to FIG. 4, shown is an example of a user interface 191, denoted herein as user interface 191b, according to various embodiments of the present disclosure. The user interface 191b includes a task list selector 403 and sets forth a task list 166 comprising a number of assigned tasks 146.

The task list selector 403 allows a service provider 126 (FIG. 1) to select any one of a number of open tasks lists 166 that includes one or more tasks 146 assigned to such service provider 126 for the instances of service provider availability 159 (FIG. 1) that they input into the service broker system 119 (FIG. 1). In one embodiment, various tasks 146 are grouped together when they involve visiting a common fulfilling venue. For example, if multiple tasks 146 involve grocery shopping at the same grocery store, then the tasks 146 may be listed in such a manner that prompts the service provider 126 to perform all three at once while they are at the store before delivering the groceries to the respective service requestors 129 as can be appreciated.

Also shown are buttons that facilitate the generation of a shopping list in association with shopping tasks 146. In a similar manner, other components may be presented in association with various tasks 146 to provide additional information as needed to fulfill such tasks 146 as can be appreciated. In one embodiment, the task list 166 is optimized to maximize efficiency and performance of the listed tasks 146. For example, it may be that the order in which such tasks 146 appear in the task list 166 minimizes travel between the performance of tasks 146 as can be appreciated. In addition, it is possible that other types of components may be presented in the user interface 191b as can be appreciated.

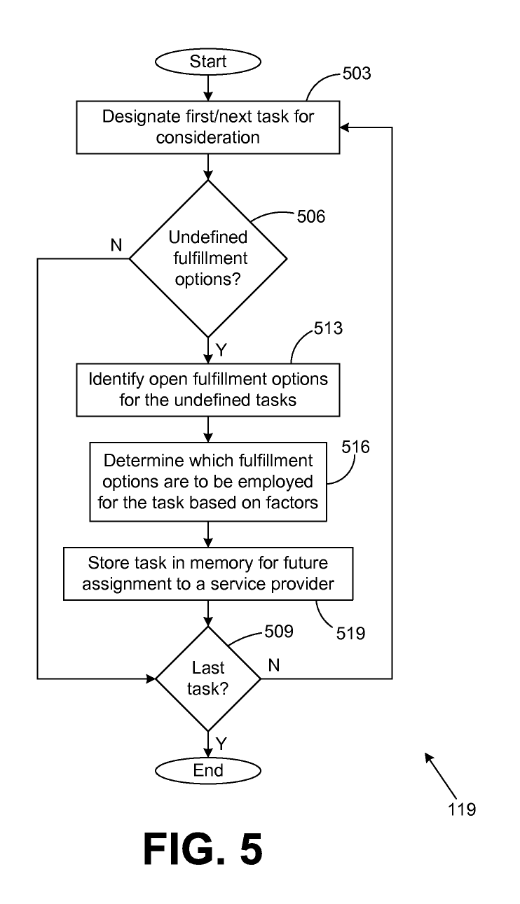

Referring next to FIG. 5, shown is a flowchart that provides one example of the operation of a portion of the service broker system 119 according to various embodiments. It is understood that the flowchart of FIG. 5 provides merely an example of the many different types of functional arrangements that may be employed to implement the operation of the portion of the service broker system 119 as described herein. As an alternative, the flowchart of FIG. 5 may be viewed as depicting an example of steps of a method implemented in the computing device 103 (FIG. 5) according to one or more embodiments.

The flowchart of FIG. 5 shows one example of a portion of a functionality of the service broker system 119 in defining one or more tasks 146 (FIG. 1) that have one or more undefined fulfillment options associated therewith. As mentioned above, such fulfillment options may comprise, for example, a choice of fulfillment venue, a selection of transportation mode, or other open fulfillment option relating to a specific task 146.

Beginning with box 503, the service broker system 119 designates a first one of the tasks 146 stored in the data store 116 (FIG. 1) that has not been assigned to a service broker 126 for consideration. Thereafter, in box 506, it is determined by the service broker system 119 whether there are any undefined fulfillment options associated with the respective task 146 examined. If not, then the service broker system 119 proceeds to box 509. Otherwise, the service broker system 119 progresses to box 513.

In box 513, the service broker system 119 identifies the particular open fulfillment options that have not been defined for the undefined task 146. Then, in box 516, the service broker system 119 determines which fulfillment options are to be employed for the task 146 based on one or more factors.

In one embodiment, the primary factor to consider is an ultimate efficiency in performing the task 146. Specifically, if a given fulfillment venue or other aspect of the fulfillment option would present a lesser efficiency relevant to other options, then the service broker system 119 may select the optimal one of the fulfillment options to promote the greatest efficiency in performing the task 146. For example, if a particular fulfillment venue such as a store is located quite a distance outside of a general location indicated by the service requestor 129 (FIG. 1), then the service broker system 119 may select other fulfillment venues that are closer to the location that is identified. Also, where one transportation mode might require a greater expenditure of energy than another, it may be the case that the transportation mode that expends the least amount of energy is selected.

Another factor to consider is the cost associated with each of the fulfillment options for the respective task 146. For example, if the fulfillment options present two different fulfillment venues that may be frequented to complete the task 146 that involves purchasing items on behalf of the service requestor 129, then the prices of such items may be consulted at each of the fulfillment venues and the fulfillment venue that presents the lowest price may be selected. Similarly, if one transportation mode presents a greater expenditure to employ than another, then the least costly transportation mode may be selected. In order to facilitate a determination of cost in this sense, the service broker system 119 may interact with merchant systems through a network to obtain pricing information of items sold in their stores as can be appreciated.

Thus, the various factors that may be considered in determining a fulfillment option for a respective task 146 include efficiency, cost to the service provider 126, cost to the service requestor 129, or other factors. Ultimately, the service broker system 119 selects the respective fulfillment options for the task 146 so that it is fully defined and can be assigned to a respective service provider 126.

In some cases, when defining a task by determining a given fulfillment option, it may be the case that a conflict may arise between two or more factors considered as described above. For example, in some situations a cost to the service requestor 129 for the performance of a task by a given service provider 126 may be lower if a first fulfillment option is specified for the task, but the efficiency in performing the task may be higher if a second fulfillment option is specified. In such case, the service broker system 119 is configured to resolve such a conflict. In one embodiment, such conflicts may be resolved using rules or some other approach may be used. For example, a rule may be specified that cost to a service requestor 129 is always taken into account before efficiency in performing the task, etc.

Thereafter, once the service broker system 119 has defined the given task 146, in box 519 the current task 146 is stored in the data store 116 (FIG. 1) for future assignment to one of the service providers 126 as will be described. Thereafter, the service broker system 119 progresses to box 509.

In box 509, the service broker system 119 determines whether the last task 146 has been considered. If so, then the service broker system 119 ends as shown. Otherwise, the service broker system 119 reverts back to box 503 to designate the next task 146 for consideration. To this end, the service broker system 119 may be run periodically to ensure that the tasks 146 stored in the data store 116 do not have unspecified fulfillment options that prevent such tasks 146 from being assigned to service providers 126. Alternatively, this portion of the service broker system 119 may be executed in a continuous manner to provide for timely definition of tasks 146 as can be appreciated.

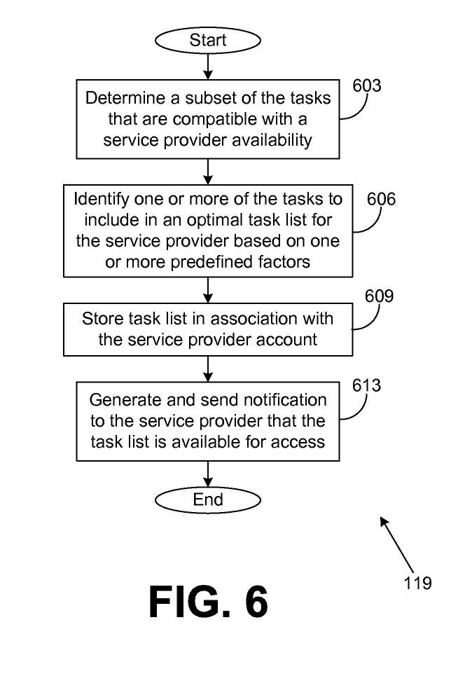

Referring next to FIG. 6, shown is a flowchart that provides one example of the operation of a portion of the service broker system 119 according to various embodiments. It is understood that the flowchart of FIG. 6 provides merely an example of the many different types of functional arrangements that may be employed to implement the operation of the portion of the service broker system 119 as described herein. As an alternative, the flowchart of FIG. 6 may be viewed as depicting an example of steps of a method implemented in the computing device 103 (FIG. 1) according to one or more embodiments.

The flowchart of FIG. 6 sets forth functionality of the service broker system 119 in assigning tasks 146 (FIG. 1) to service providers 126 (FIG. 1). Specifically, the functionality of FIG. 6 is implemented to generate a task list 166 (FIG. 1) for a given instance of service provider availability 159 (FIG. 1).

Beginning in box 603, the service broker system 119 first determines a subset of all the tasks 146 in the data store 116 (FIG. 1) that are ultimately compatible with a given instance of service provider availability 159 specified by a respective service provider 126. In order to determine whether a given task 146 is compatible with an instance of service provider availability 159, various factors that are associated with both the prospective task 146 and the instance of service provider availability 159 may be examined for a match.

For example, a respective time window and location that a service provider 126 has specified should fit within the time window specified by the service requestor 129 (FIG. 1). Also, the type of task 146 requested should match the type of task 146 that the service provider 126 is willing to perform. In addition, other parameters associated with a given instance of service provider availability 159 may need to match with the parameters of a given task 146 in order to determine whether such task 146 is compatible with the instance of service provider availability 159. Once an initial pool of tasks 146 is identified that are compatible with the instance of service provider availability 159 considered, then the service broker system 119 proceeds to box 606.

In box 606, the service broker system 119 identifies one or more tasks 146 to include in an optimized task list 166 (FIG. 1) for the respective instance of service provider availability 159 based on one or more factor or considerations. Specifically, there are several factors that may be considered in assigning respective tasks 146 for a given instance of service provider availability 159 for a service provider 126. Such factors may be taken into account in one of many approaches that may be employed in assigning such tasks 146.

For example, in one approach multiple different combinations of tasks 146 may be generated based on the tasks 146 identified that are compatible with the instance of service provider availability 159. Such combinations are groupings of tasks 146 that can be performed in the time window specified by the service provider 126 in the respective instance of service provider availability 159 addressed. Ultimately an optimal one of these combinations may be selected and corresponding tasks 146 included therein may be assigned to the service provider 126.

In determining which combination of tasks 146 is optimal, the service broker system 119 may examine multiple factors. Such factors may include, for example, whether multiple ones of the tasks 146 may be completed via a common fulfillment venue. According to one embodiment, the service broker system 119 may generate the task list 166 to include two or more tasks 146 therein that use the common fulfillment venue to increase the efficiency of the fulfillment of the respective tasks 146. In some cases, two or more of the tasks 146 that are combined in such a manner may have been requested from different service requestors 129.

Another factor that may be considered in determining an optimal task list 166 is a desire to maximize the profitability to the service provider 126. For example, combinations of respective ones of the tasks 146 may be selected that maximize a total number of the tasks 146 that can be performed by a service provider 126 within the bounds of a given instance of service provider availability 159.

It may be, for example, that different combinations of tasks 146 may facilitate a greater or lesser number of tasks 146 that can be completed within a given instance of service provider availability 159. This is because some tasks 146 may require greater amounts of travel or other activity relative to other tasks 146 as can be appreciated. For example, it may be the case that a single large task 146 takes the same amount of time to complete as three smaller tasks 146. If the three smaller tasks would result in a greater profit for the service provider 126, then such may be preferable over the single larger task 146.

Another factor to consider in determining which tasks 146 are to be assigned to a service provider 126 for a given instance of service provider availability involves the calculation of a cost for the service provider 126 to perform each of the respective tasks 146. The calculation of such cost may take into account various factors such as transportation cost of the service provider 126 based on the information input using the possible transportation mode components 316 (FIG. 3) as described above. For example, the type of vehicle employed may be determined to have a given mileage, thereby providing a cost per mile given current fuel pricing.

Still another factor to consider in determining which one of the tasks 146 to assign to a given service provider 126 may involve the level of efficiency of each of the tasks 146 that may be performed relative to other tasks 146 in a given combination. For example, if a service provider 126 is performing a delivery for a first service requestor 129 and drops an item off at their location, the fact that another delivery that is to originate at a location nearby might be taken into account such that the minimum amount of energy and time is expanded in transit between the performance of two different tasks 146. To this end, for each permutation of groupings of tasks 146 generated for examination, the efficiency of the relative placement of such tasks 146 in a given task list 166 may be considered.

Yet another factor to consider is the cost of the service requestor 129. Specifically, where service providers 126 have effectively provided bids to perform various tasks 146, the lower ones of the bids may be given preference in terms of whether a given task 146 is assigned to a given service provider 126. That is to say, a task 146 may be assigned to lower bidders before higher bidders.

In addition, there may be many other factors applied to determine an optimal task list 166 of tasks 146 for a service provider 126 to perform. Alternatively, other approaches may be used to assign tasks 146 to a service provider 126. For example, tasks 146 may merely be selected at random. Alternatively, various rules may be applied such as determining a maximum number of tasks 146 of those pending that can be assigned. Still other approaches may be employed.

Note that assuming that an ultimate group of tasks 146 is identified, then an optimal ordering of the tasks 166 within the task list 166 may be performed to ensure maximum efficiency. Specifically, transition time and energy expanded between tasks 146 may be minimized and other factors may be considered as well.

Assuming that one or more tasks 146 has been identified for the task list 166 in box 606, then in box 609 the service broker system 119 stores the task list 166 in association with the service provider account 123 (FIG. 1) of the respective service provider 126. Such task lists 166 are stored in association with the respective instance of the service provider availability 159. Thereafter, in box 613 the service broker system 119 is configured to generate and send a notification to the respective service provider 126 that a task list 166 is available for access. At such time, the service provider 126 may access the task list as was described above with respect to FIG. 4. Thereafter, the service broker system 119 ends as shown.

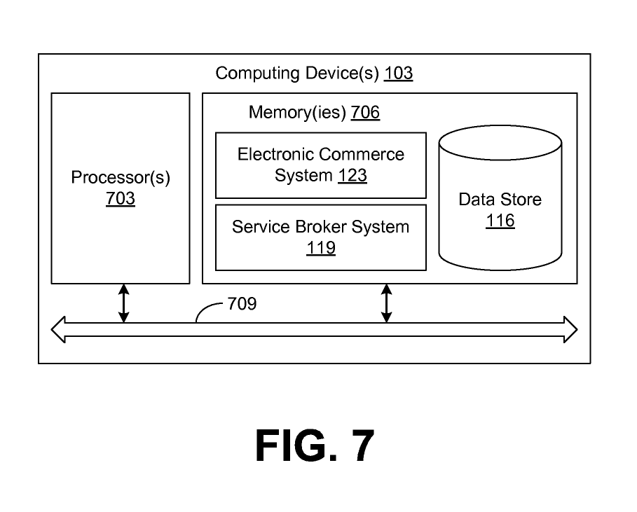

With reference to FIG. 7, shown is a schematic block diagram of the computing device 103 according to an embodiment of the present disclosure. The computing device 103 includes at least one processor circuit, for example, having a processor 703 and a memory 706, both of which are coupled to a local interface 709. To this end, the computing device 103 may comprise, for example, at least one server computer or like device. The local interface 709 may comprise, for example, a data bus with an accompanying address/control bus or other bus structure as can be appreciated.

Stored in the memory 706 are both data and several components that are executable by the processor 703. In particular, stored in the memory 706 and executable by the processor 703 are the service broker system 119, the electronic commerce system 123, and potentially other systems or applications. Also stored in the memory 706 may be the data store 116 and other data. In addition, an operating system may be stored in the memory 706 and executable by the processor 703.

It is understood that there may be other applications that are stored in the memory 706 and are executable by the processors 703 as can be appreciated. Where any component discussed herein is implemented in the form of software, any one of a number of programming languages may be employed such as, for example, C, C++, C#, Objective C, Java, Javascript, Perl, PHP, Visual Basic, Python, Ruby, Delphi, Flash, or other programming languages.

A number of software components are stored in the memory 706 and are executable by the processor 703. In this respect, the term “executable” means a program file that is in a form that can ultimately be run by the processor 703. Examples of executable programs may be, for example, a compiled program that can be translated into machine code in a format that can be loaded into a random access portion of the memory 706 and run by the processor 703, source code that may be expressed in proper format such as object code that is capable of being loaded into a random access portion of the memory 706 and executed by the processor 703, or source code that may be interpreted by another executable program to generate instructions in a random access portion of the memory 706 to be executed by the processor 703, etc. An executable program may be stored in any portion or component of the memory 706 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 706 is defined herein as including both volatile and nonvolatile memory and data storage components. Volatile components are those that do not retain data values upon loss of power. Nonvolatile components are those that retain data upon a loss of power. Thus, the memory 706 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 703 may represent multiple processors 703 and the memory 706 may represent multiple memories 706 that operate in parallel processing circuits, respectively. In such a case, the local interface 709 may be an appropriate network that facilitates communication between any two of the multiple processors 703, between any processor 703 and any of the memories 706, or between any two of the memories 706, etc. The local interface 709 may comprise additional systems designed to coordinate this communication, including, for example, performing load balancing. The processor 703 may be of electrical or of some other available construction.

Although the service broker system 119 and the electronic commerce system 123, and any other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowcharts of FIGS. 5 and 6 show the functionality and operation of examples of an implementation of portions of the service broker system 119. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 703 in a computer system or other system. The machine code may be converted from the source code, etc. If embodied in hardware, each block may represent a circuit or a number of interconnected circuits to implement the specified logical function(s).

Although the flowcharts of FIGS. 5 and/or 6 show a specific order of execution, it is understood that the order of execution may differ from that which is depicted. For example, the order of execution of two or more blocks may be scrambled relative to the order shown. Also, two or more blocks shown in succession in FIGS. 5 and/or 6 may be executed concurrently or with partial concurrence. Further, in some embodiments, one or more of the blocks shown in FIGS. 5 and/or 6 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the service broker system 119 and the electronic commerce system 123, that comprises software or code can be embodied in any non-transitory computer-readable medium for use by or in connection with an instruction execution system such as, for example, a processor 703 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A non-transitory computer-readable medium embodying computer-readable instructions stored thereon that, when executed by a computing device, directs the computing device to perform a method comprising:
receiving a time window of availability and a location for a service provider;
receiving a plurality of requests to complete a plurality of tasks from a plurality of service requestors, at least one of the plurality of requests including a fulfillment requirement;
identifying an undefined fulfillment option in the at least one of the plurality of tasks;
in response to identifying the undefined fulfillment option, selecting a fulfillment option for the at least one of the plurality of tasks based on at least one rule;
determining a subset of tasks among the plurality of tasks to assign to a task list for the service provider with reference to the time window of availability for the service provider, the location for the service provider, and the fulfillment requirement;
optimizing the task list for at least one metric of efficiency for the service provider with reference to the fulfillment requirement; and
sending a notification of an availability of the task list to the service provider.

2. The computer-readable medium of claim 1, wherein the fulfillment requirement specifies a fulfillment venue and a time for completion of the at least one of the plurality of tasks.

3. The computer-readable medium of claim 1, wherein:
selecting the fulfillment option comprises selecting a fulfillment venue from among a plurality of fulfillment venues based on transportation costs for the service provider; and
optimizing the task list comprises ordering a sequence of the subset tasks based on the transportation costs for the service provider.

4. The computer-readable medium of claim 1, wherein selecting the fulfillment option comprises:
obtaining pricing information from a plurality of fulfillment venues through a computer network; and
selecting one of the plurality of fulfillment venues for the at least one of the plurality of tasks based on the pricing information.

5. The computer-readable medium of claim 1, wherein selecting the fulfillment option comprises:
obtaining pricing information from a plurality of fulfillment venues through a computer network;
identifying a transportation cost for the service provider associated with individual ones of the plurality of fulfillment venues; and
selecting one of the plurality of fulfillment venues for the at least one of the plurality of tasks based on a rule that accounts for the pricing information before the transportation cost for the service provider associated with the individual ones of the plurality of fulfillment venues.

6. A system, comprising:
a memory embodying computer-readable instructions; and
a computing device coupled to the memory and directed through execution of the computer-readable instructions to at least:
receive a time window of availability for a service provider;
receive a plurality of requests to complete a plurality of tasks from a plurality of service requestors, at least one of the plurality of requests including a fulfillment requirement;
identify an undefined fulfillment option in the at least one of the plurality of tasks;
select a fulfillment option for the at least one of the plurality of tasks based on at least one rule;
determine at least one task among the plurality of tasks to assign to a task list for the service provider with reference to the time window of availability and the fulfillment requirement; and
send a notification of an availability of the task list to the service provider.

7. The system of claim 6, wherein the fulfillment requirement specifies a fulfillment venue and a time for completion of the at least one of the plurality of tasks.

8. The system of claim 6, wherein the computing device is further directed to:
identify a location for the service requestor during the time window of availability for a service provider using a global positioning system (GPS); and
determine the at least one task among the plurality of tasks to assign to the task list for the service provider with further reference to the location of the service requestor.

9. The system of claim 8, wherein the computing device is further directed to:
determine a subset of tasks among the plurality of tasks to assign to a task list for the service provider with reference to the time window of availability, the location for the service provider, and the fulfillment requirement; and
optimize the subset of tasks in the task list for at least one metric of efficiency for the service provider.

10. The system of claim 9, wherein the computing device is further directed to:
select a fulfillment venue from among a plurality of fulfillment venues based on transportation costs for the service provider; and
order a sequence of the subset tasks based on the transportation costs for the service provider.

11. The system of claim 6, wherein the computing device is further directed to:
obtain pricing information from a plurality of fulfillment venues through a computer network; and
select one of the plurality of fulfillment venues for the at least one of the plurality of tasks based on the pricing information.

12. The system of claim 6, wherein the computing device is further directed to:
obtain pricing information from a plurality of fulfillment venues through a computer network;
identify a transportation cost for the service provider associated with individual ones of the plurality of fulfillment venues; and
select one of the plurality of fulfillment venues for the at least one of the plurality of tasks based on a rule that accounts for the pricing information before the transportation cost for the service provider associated with the individual ones of the plurality of fulfillment venues.

13. The system of claim 6, wherein the computing device is further directed to send the notification of the availability of the task list to the service provider through a client-side application executing on a client device of the service provider.

14. A method, comprising:
receiving a plurality of requests to complete a plurality of tasks, at least one of the plurality of requests including a fulfillment requirement for a delivery of at least one item to a requestor;
identifying a location for a service requestor during a time window of availability for a service provider using a global positioning system (GPS);
determine at least one task among the plurality of tasks to assign to a task list for the service provider with reference to the location for the service requestor and the fulfillment requirement; and
sending a notification of an availability of the task list to the service provider through a client-side application executing on a client device of the service provider.

15. The method of claim 14, wherein the fulfillment requirement specifies a fulfillment venue and a time for completion of the at least one of the plurality of tasks.

16. The method of claim 14, further comprising:
identifying an undefined fulfillment option in the at least one of the plurality of tasks; and
selecting a fulfillment option for the at least one of the plurality of tasks based on at least one rule.

17. The method of claim 14, further comprising:
determining a subset of tasks among the plurality of tasks to assign to the task list for the service provider with reference to the time window of availability, the location for the service requestor, and the fulfillment requirement; and
optimizing the subset of tasks in the task list for at least one metric of efficiency for the service provider.

18. The method of claim 17, further comprising:
selecting a fulfillment venue from among a plurality of fulfillment venues based on transportation costs for the service provider; and
ordering a sequence of the subset tasks based on the transportation costs for the service provider.

19. The method of claim 14, further comprising:
obtaining pricing information from a plurality of fulfillment venues through a computer network; and
selecting one of the plurality of fulfillment venues for the at least one of the plurality of tasks based on the pricing information.

20. The method of claim 14, further comprising:
obtaining pricing information from a plurality of fulfillment venues through a computer network;
identifying a transportation cost for the service provider associated with individual ones of the plurality of fulfillment venues; and
selecting one of the plurality of fulfillment venues for the at least one of the plurality of tasks based on a rule that accounts for the pricing information before the transportation cost for the service provider associated with the individual ones of the plurality of fulfillment venues.
